(19) United States
(12) Patent Application Publication
(10) Pub. No.: US 2020/0256577 A1
(43) Pub. Date: Aug. 13, 2020

(54) PREDICTIVE HVAC EQUIPMENT MONITORING SYSTEM, APPARATUS, AND METHOD

(71) Applicant: Sandeep Apsangi, Plano, TX (US)

(72) Inventor: Sandeep Apsangi, Plano, TX (US)

(21) Appl. No.: 16/864,214

(22) Filed: May 1, 2020

Related U.S. Application Data
(63) Continuation-in-part of application No. 15/834,058, filed on Dec. 7, 2017, now Pat. No. 10,677,487.

(51) Int. Cl. F24F 11/38; F24F 11/63; G05B 19/042

(52) U.S. Cl. CPC F24F 11/38; F24F 2110/10; G05B 19/042; F24F 11/63

(57) ABSTRACT

A predictive HVAC equipment monitoring system, the predictive HVAC equipment monitoring system having an HVAC system with a first sensor of a sensor array disposed a vapor refrigerant line exiting from an evaporating unit of the HVAC system, the first sensor being adapted to gather pressure data, a second sensor of the sensor array disposed on a vapor refrigerant line entering a compressor of the HVAC system, the second sensor adapted to gather temperature data, and a predictive HVAC controlling unit, the predictive HVAC controlling unit adapted to receive the temperature and pressure data and evaluate the temperature and pressure data to determine whether a potential failure modality exists or is eminent, the first sensor further adapted to communicate with the predictive HVAC controlling unit, and the second sensor further adapted to communicate with the predictive HVAC controlling unit.

### CROSS REFERENCE TO RELATED APPLICATIONS

The present application is a continuation-in-part of co-pending application Ser. No. 15/834,058 filed Dec. 7, 2017, which is incorporated herein by reference.

### FIELD OF THE INVENTION

The present invention relates to heating, ventilation, and air conditioning (HVAC) systems, in particular, a predictive HVAC equipment monitoring system to measure, compute, evaluate, and communicate HVAC system equipment, parameters, predict a future system failure, and proactively prevent system issues by taking control of the HVAC system.

### BACKGROUND INFORMATION

Heating, ventilation, and air conditioning systems are standard components of modern homes and businesses. Responsible for providing comfortable ambient temperatures and good air quality, HVAC systems are one of the most critical aspects of a property and one of the most expensive to repair or replace. HVAC systems additionally provide adequate ventilation between areas of a house, filter air circulating within a home, and maintain pressure relationships between individual spaces. For those who live in areas with extreme weather conditions, it is particularly imperative to have a constantly functioning HVAC system. For example, during periods of continuous hot weather a broken HVAC unit can contribute to incidences of hyperthermia, especially in older adults and young children.

Once an HVAC system is installed, a prudent end user ensures that is it inspected at least annually to ensure that the system is functioning properly. This however is not often the case. These inspections require time, money, and diligence resulting in many end users failing to check their HVAC system after it has been installed. Furthermore, a typical end user does not have the knowledge base or the tools required to perform even basic maintenance on an HVAC system on their own. Because most end users do not regularly maintain their HVAC systems, when an issue does arise it is often after the HVAC system breaks down. Even when an end user has been responsible about getting bi-annual maintenance checks, these inspections are simple usually involving checking the system charge, air filter, line pressures, condensate drains, controls, visually checking connections, and a rudimentary inspection of the evaporator and condenser coils. Some problems may be found and the life of the system may be assessed however, these maintenance checks cannot predict specific times when the HVAC system will incur an issue.

When residential HVAC systems incur problems or break down, it can take a while for a repairperson to come out to investigate and fix the issue. Service calls to HVAC service professionals can be costly and time intensive. Often, if a problem occurs during the weekend, an end user may have to wait up to 72 hours or more for a repairperson to investigate a broken HVAC system. This can be hazardous to the end user if the system goes down during a heat wave or during a period of extremely cold weather. The elderly and very young children are particularly susceptible to heat stroke and hypothermia because they cannot regulate their body temperatures as well as adults. Therefore, a nonfunctioning HVAC system can be dangerous to end users and any delay in its repair increases the likelihood of harm falling upon the residents. Additionally, during especially busy times, there may be a long line of customers having issues with their HVAC systems causing delays in having broken systems investigated putting the elderly and young children in even greater danger.

Most residential and commercial HVAC systems are mass-produced with capacity to match heating and cooling load as the most distinguishing factor between different units within a single brand. Generally, current residential or commercial systems have two major elements, an outdoor compressor/condenser unit and an indoor/evaporator unit, connected by refrigeration lines. An air conditioning system operates by taking warm air from the house, cooling it, and cycling it back through the house via a system of ducts. To cool the air, the collected warm air is blown across the indoor/evaporator unit, namely the evaporator coil. Refrigerant flows through the evaporator coil allowing the heat energy to transfer between the warm air and the refrigerant. By absorbing the heat from the warm air, the refrigerant transitions in state from a liquid to a gaseous vapor and the vapor is then pumped to the outdoor compressor/condenser unit. The vaporized refrigerant is compressed increasing the pressure and temperature of the vapor and then it moves through a condensing coil losing heat to the outdoors. This causes the vaporized refrigerant to cool and condense so that the refrigerant again transitions in state from a gaseous vapor back to a liquid. The liquid refrigerant then cycles back to the evaporator to start the process over again.

Generally, a home or building owner will not know if their HVAC system is incurring an issue until the problem has reached a critical stage and the system is down. Most residential and commercial HVAC systems are not equipped with the technology for real-time monitoring so the end user will not know the issue, just that the system is not functioning properly. Creating a system that comprehensively monitors HVAC systems in real-time would be cost-prohibitive to manufacturers due to the several expensive sensors and additional electronics that would need to be disposed within the entire system. It is therefore preferred to use as few sensors as possible to assess the functionality and efficiency of a system in order to monitor functionality. Current systems that are enabled with sensors merely provide information on ambient temperatures around the condenser, evaporator coils, and the dwelling. These systems do not provide clear information regarding the operating parameters, specifically, the parameters related to refrigerant pressures and temperatures, to fix the problems associated with the actual system operations. Furthermore, these systems fail to provide specific diagnostics to the end user, repairpersons, or air conditioning contractors to direct attention towards a specific point of failure in order to efficiently troubleshoot the HVAC system. Additionally, monitoring an HVAC system in real-time fails to resolve the wait time for a service professional to repair a broken system even though the repair itself may take less time because the problem can be quickly identified. Rather, an HVAC system comprising few sensors to collect data and predictive HVAC control apparatus to monitor fundamental operating elements of the system, predictively assess an impeding system failure, and taking control of the HVAC system to prevent a possible system failure is preferred. Such a system would proactively shut down a failing HVAC system and allow a responsible party to contact a repairperson to investigate the potential problem thereby preventing a total system failure, minimizing the time required to fix the issue, and minimizing the cost by being able to rectify the problem before it exacerbates into larger expense such as a total system failure.

### BRIEF DESCRIPTION OF THE DRAWINGS

These and other features and advantages of the present invention will be better understood by reading the following Detailed Description, taken together with the Drawings wherein:

FIG. 1 shows a diagram of a system in accordance with one or more embodiments of the present invention installed on a generic HVAC system.

FIG. 2 shows a diagram of a system in accordance with one or more embodiments of the present invention installed on a generic HVAC system in accordance with an alternative embodiment of the present invention.

FIG. 3 shows a diagram of a system in accordance with one or more embodiments of the present invention installed on a generic HVAC system in accordance with another alternative embodiment of the present invention.

FIG. 4 shows a diagram of a predictive HVAC controlling unit in accordance with one or more embodiments of the present invention.

FIG. 5a shows a flowchart in accordance with an embodiment of the present invention.

FIG. 5b shows a flowchart in accordance with an embodiment of the present invention.

FIG. 6 shows a detailed flowchart in accordance with an embodiment of the present invention.

FIG. 7 shows a detailed flowchart in accordance with an embodiment of the present invention.

FIG. 8 shows a detailed flowchart in accordance with an embodiment of the present invention.

### DETAILED DESCRIPTION OF THE PREFERRED EMBODIMENTS

Specific embodiments of the invention will now be described in detail with reference to the accompanying figures. Like elements in the various figures are denoted by like reference numerals for consistency, simplicity, and clarity. The repetition of reference numerals does not in itself dictate a relationship between the various embodiments of the invention. In the following detailed description of embodiments of the invention, numerous specific details are set forth in order to provide a more thorough understanding of the invention. Specific examples of components and arrangements are described below to simplify the present disclosure. These are, of course, merely examples and are not intended to be limiting. However, it will be apparent to one of ordinary skill in the art that the invention may be practiced without these specific details to avoid unnecessary complicating the description.

Certain embodiments of the present disclosure are directed to a system, apparatus, and method for a predictive HVAC equipment monitoring system. The HVAC equipment monitoring system comprises a plurality of sensors configured to measure and monitor operational and air-side properties and a predictive HVAC controlling unit configured to evaluate the operational and air-side properties, forecast potential failure modalities, and alert an end user of any deduced forecasted potential failure modalities. In an embodiment of the invention, the system is further configured to send the forecasted potential failure modality alert to an end user such as an owner, monitoring service, manufacturer, or OEM parts distributor.

The predictive HVAC controlling unit is configured to measure and assess refrigerant and air parameters, other operational data, power consumption, predict and provide system maintenance and malfunction information, and take control of the HVAC system to avoid further damage. In certain embodiments, the predictive HVAC controlling unit is configured to receive operational data such as refrigerant and air functional characteristics from a plurality of sensors placed in an HVAC system. The predictive HVAC controlling unit is further configured to analyze refrigerant and air functional characteristics by amplifying, calibrating, and manipulating the received refrigerant and air functional characteristics, calculate performance metrics of the HVAC system, determine optimal efficiency performance metrics for the HVAC system, and take control of the HVAC system to shift current performance metrics of the HVAC system towards the optimal efficiency performance metrics.

In general, in one aspect, the invention relates to a method for predicting an HVAC system failure and alerting an end user of the potential system failure. The method comprises receiving, by a predictive HVAC controlling unit, operational data including refrigerant and air functional characteristics data from a plurality of sensors, evaluating the received refrigerant and air functional characteristics data, forecasting potential failure modalities, and alerting an end user of any deduced potential failure modalities. The method further comprises sending an alert to a monitoring service and contacting an HVAC serviceperson to inspect the HVAC system.

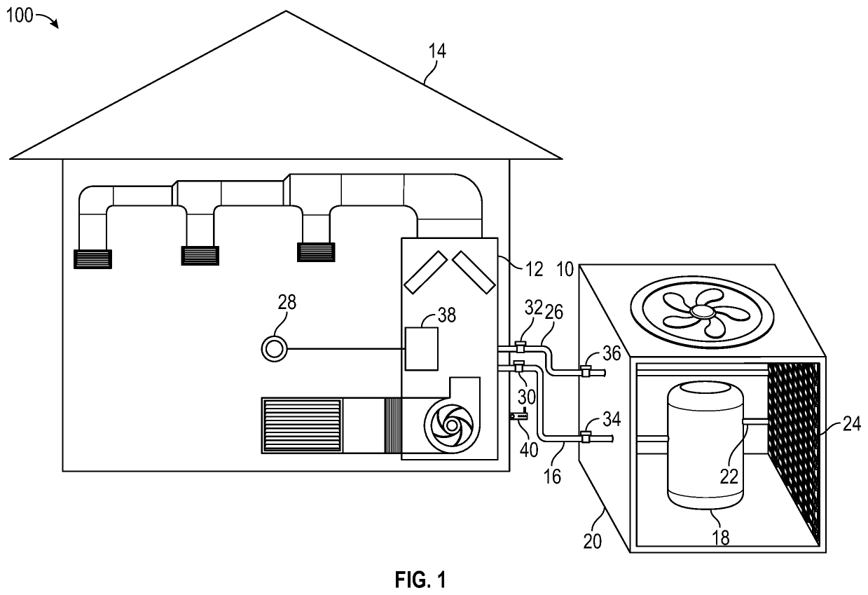

The embodiment of FIG. 1 provides an embodiment of predictive HVAC equipment monitoring system 1 including predictive HVAC controlling unit 38 and sensor array, generally designated by reference numeral 10, installed on a generic HVAC system 100, according to the principles of the present invention. Predictive HVAC controlling unit 38 is connected, wired or wirelessly, to sensor array 10 and is configured to communicate with individual sensors in sensor array 10. Generic HVAC system 100 includes evaporating unit 12 generally located within interior of residence 14, vapor refrigerant line 16 connecting evaporating unit 12 to compressor 18 generally located outside of residence 14 and housed within outdoor HVAC unit 20, high pressure gas line 22 connecting compressor 18 to condensing unit 24, liquid refrigerant line 26 connecting condensing unit 24 to evaporating unit 12, and thermostat 28 configured to control HVAC system 100 and receive inputs from predictive HVAC controlling unit 38. In certain embodiments, as shown in FIG. 1, generic HVAC system 100, predictive HVAC controlling unit 38, and sensor array 10 are on-site or installed inside residence 14 however one knowledgeable in the art will appreciate that generic HVAC system 100, predictive HVAC controlling unit 38, and sensor array 10 may be installed on any type of HVAC system including but not limited to residential and commercial systems. One knowledgeable in the art will further appreciate that predictive HVAC controlling unit 38 and sensor array 10 may be installed on any brand of HVAC system and, in certain embodiments, may operate as a modular system, independent of a particular manufacturer.

Refrigerant and air characteristics including temperature, pressure, power, airflow, relative humidity, and static pressure are measured by sensors 30, 32, 34, 36, 44, 48, 52, 54, 56, 60, 66, 68, 80, 82, 84, and 86 disposed throughout HVAC system 100 in sensor array 10. Sensor array 10 includes sensors 30, 32, 34, and 36 disposed on refrigerant lines 16 and 26. Sensors 30, 32, 34, and 36 can each be any commercially available sensor enabled to measure pressure and temperature of vapor or liquid refrigerant flowing through refrigerant lines 16 and 26. In certain embodiments of the invention, sensors 30, 32, 34, and 36 are wirelessly-enabled. One knowledgeable in the art will appreciate that any wireless technology may be used by sensors 30, 32, 34, and 36 including Bluetooth, Wi-fi, ZigBee, WIMAX, infrared, RFID, and any other wireless technology to communicate pressure and temperature measurements or pressure and temperature data to predictive HVAC controlling unit 38. In certain embodiments, predictive HVAC controlling unit 38 is off-site. In certain embodiments, predictive HVAC controlling unit 38 may be hosted on a cloud-based application server. In certain embodiments, sensors 30, 32, 34, and 36 are enabled to communicate wirelessly to wireless gateway 40 using any wireless technology including Bluetooth, Wi-fi, ZigBee, WIMAX, infrared, RFID, or cellular technologies. In certain embodiments, on-site predictive HVAC controlling unit 38 sends pressure and temperature measurements or other sensor data to wireless gateway 40. In certain embodiments, wireless gateway 40 is configured to send pressure and temperature measurements or other sensor data to database server 42. Database server 42 may be a cloud-based database server. In certain embodiments, wireless gateway 40 is configured to send pressure and temperature measurements or other sensor data to off-site predictive HVAC controlling unit 38. In certain embodiments, predictive HVAC controlling unit 38 is enabled to communicate with the sensors 30, 32, 34, and 36 wirelessly. In certain embodiments of the invention, sensors 30, 32, 34, and 36 are wired directly to predictive HVAC controlling unit 38 and are configured to communicate with predictive HVAC controlling unit 38.

In an embodiment of the invention, sensor 30 is a pressure sensor disposed on vapor refrigerant line 16 exiting from the evaporating unit 12 inside residence 14, sensor 32 is a pressure sensor disposed on liquid refrigerant line 26 entering into evaporating unit 12 inside residence 14, sensor 34 is a pressure and temperature sensor disposed on vapor refrigerant line 16 entering compressor 18 outside residence 14, and sensor 36 is a pressure and temperature sensor disposed on liquid refrigerant line 26 exiting from condensing unit 24 outside residence 14. In an alternate embodiment of the invention the temperature and pressure measurements or temperature and pressure data measured by sensor 34 may be performed by two sensors each tasked with gathering either temperature or pressure data. In an alternate embodiment of the invention the temperature and pressure data measured by sensor 36 may be performed by two sensors each tasked with gathering either temperature or pressure data. In certain embodiments of the invention, sensors 30 and 32 additionally gather temperature data.

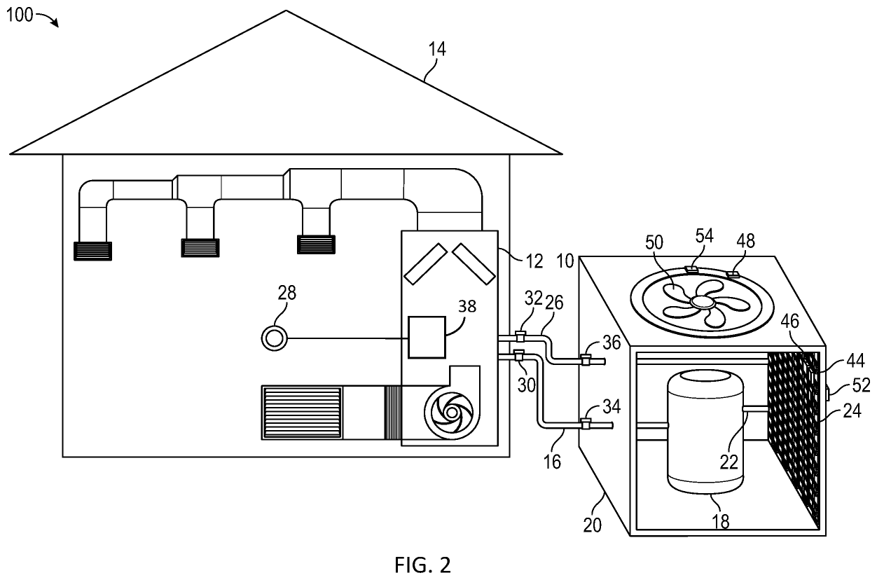

FIG. 2 depicts air inlet temperature sensor 44 positioned in the air stream of the external surface of outdoor HVAC unit 20 proximate to condensing unit 24 and adjacent to inlet vent 46. Air outlet temperature sensor 48 is positioned in the air stream of the outdoor HVAC unit 20 above condensing unit 24 and adjacent to outlet fan 50. In this embodiment of the invention, air inlet static pressure sensor 52 is disposed in the air stream around the outdoor HVAC unit 20 lateral to condensing unit 24 and adjacent to inlet vent 46 and air outlet static pressure sensor 54 is disposed on an external surface of outdoor HVAC unit 20 above condensing unit 24 and adjacent to outlet fan 50. Air inlet and air outlet static pressure sensors 52 and 54, respectively, can be any commercially available device for measuring static pressure including static pressure taps, static pressure fittings, static pressure tips, and static pressure tubes. In certain embodiments, sensor array 10 includes sensors 44, 48, 52, and 54. In certain embodiments of the invention, sensors 44, 48, 52, and 54 are enabled to wirelessly communicate with predictive HVAC controlling unit 38. In certain embodiments, sensors 44, 48, 52, and 54 are enabled to communicate wirelessly to wireless gateway 40 using any wireless technology including Bluetooth, Wi-fi, ZigBee, WIMAX, infrared, RFID, or cellular technologies. In certain embodiments of the invention, sensors 44, 48, 52, and 54 are wired directly to predictive HVAC controlling unit 38.

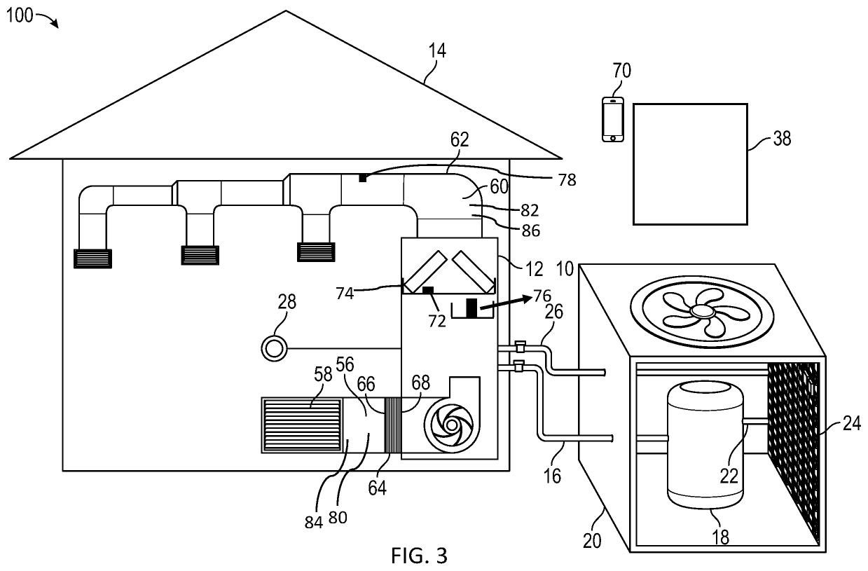

FIG. 3 depicts return air temperature sensor 56 and supply air temperature sensor 60 inside residence 14. In certain embodiments of the invention, return air temperature sensor 56 may be disposed in the air stream of the return air duct 58. In certain embodiments of the invention, supply air temperature sensor 60 may be positioned in the air stream of supply air duct 62. Filter 64 is placed between the return air duct 58 and evaporating unit 12. In certain embodiments of the invention, duct-side static pressure sensor 66 is disposed adjacent to a surface of the filter 64 facing return air duct 58 and unit-side static pressure sensor 68 is disposed adjacent to a surface of filter 64 facing evaporating unit 12. Duct-side and unit-side static pressure sensors 66 and 68, respectively, can be any commercially available device for measuring static pressure including static pressure taps, static pressure fittings, static pressure tips, and static pressure tubes. In certain embodiments, return air temperature sensor 56 is configured to determine the dry bulb temperature of the return air. In certain embodiments, return dry bulb sensor 80 is disposed in in the air stream of return air duct 58 and configured to determine the dry bulb temperature of the return air. In certain embodiments, supply air temperature sensor 60 is configured to determine the dry bulb temperature of the supply air. In certain embodiments, supply dry bulb sensor 82 is disposed in in the air stream of supply air duct 62 and configured to determine the dry bulb temperature of the supply air. In certain embodiments return relative humidity sensor 84 is disposed in the air stream of return air duct 58. In certain embodiments supply relative humidity sensor 86 is disposed in the air stream of supply air duct 62. In certain embodiments, sensor array 10 includes sensors 56, 60, 66, 68, 80, 82, 84, and 86. In certain embodiments of the invention, sensors 56, 60, 66, 68, 80, 82, 84, and 86 are enabled to wirelessly communicate with predictive HVAC controlling unit 38. In certain embodiments, sensors 56, 60, 66, 68, 80, 82, 84, and 86 are enabled to communicate wirelessly to wireless gateway 40 using any wireless technology including Bluetooth, Wi-fi, ZigBee, WIMAX, infrared, RFID, or cellular technologies. In certain embodiments of the invention, sensors 56, 60, 66, 68, 80, 82, 84, and 86 are wired directly to predictive HVAC controlling unit 38.

In certain embodiments, sensor array 10 includes water leak sensor 72. In such an embodiment, water leak sensor 72 is disposed in drain pan 74 and configured detect excess water in drain pan 74. Water leak sensor 72 may be any commercially available water detection sensor or water detector or leak detector including puck-style water sensors, rope-style water sensors, or any device enabled to detect the presence of water in drain pan 74. Water leak sensor 72 may be wired to predictive HVAC controlling unit 38 or may communicate wirelessly to predictive HVAC controlling unit 38. In certain embodiments float switch 76 may be installed on generic HVAC system 100 and may be disposed in a secondary drain pan as is shown in FIG. 3, drain pan 74, or drain pipe. Float switch 76 may be any commercially available float or wet switch and is configured to communicate wired or wirelessly with predictive HVAC controlling unit 38. In such embodiments, sensor array 10 includes float switch 76.

In certain embodiments, sensor array 10 includes sail switch 78. Sail switch 78 may be disposed in supply air duct 62 and configured to detect whether there is air flow in generic HVAC system 100. Sail switch 78 may be any commercially available sail switch or air flow detector and is configured to communicate wired or wirelessly with predictive HVAC controlling unit 38.

In certain embodiments of the invention, predictive HVAC controlling unit 38 is off-site and is further configured to communicate with a mobile device 70. In certain embodiments of the invention, predictive HVAC controlling unit 38 is on-site or proximate to HVAC system 100, either inside or outside the building, and is further configured to communicate with a mobile device 70. Mobile device 70 may be configured to receive refrigerant parameters, a potential HVAC system failure alert, and a HVAC control action alert from predictive HVAC controlling unit 38. Mobile device 70 may also be configured to communicate with predictive HVAC controlling unit 38, set up predictive HVAC controlling unit 38, and configure predictive HVAC controlling unit 38. Mobile device 70 may be further configured to view refrigerant parameters, a potential HVAC system failure alert, a HVAC control action alert from predictive HVAC controlling unit 38, and HVAC system status or efficiency for multiple HVAC systems having of predictive HVAC equipment monitoring system 1 installed on them. In certain embodiments, mobile device 70 may be configured to communicate with predictive HVAC controlling unit 38 wirelessly using any wireless technology including Bluetooth, Wi-fi, ZigBee, WIMAX, infrared, RFID, or cellular technologies.

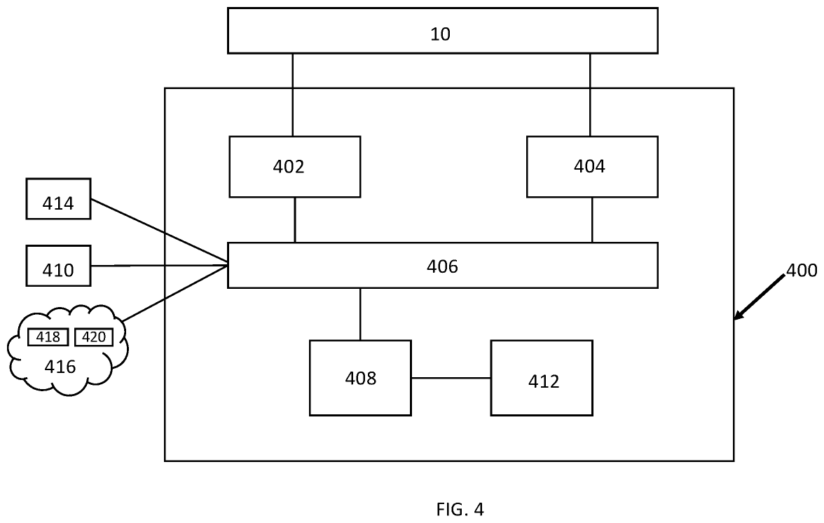

FIG. 4 shows a top-level internal view of the predictive HVAC controlling unit 38. Predictive HVAC controlling unit 38 is disposed in housing 400. Gain amplifier 402 processes analog signals of the sensors and is coupled to input/output interface 406. Gain amplifier 402 receives voltage measurements from sensor array 10 and converts voltage measurements into gain-based digital values. Input/output interface 406 is also coupled to temperature amplifier 404 and central processing unit 408. Temperature amplifier 404 receives voltage measurements from sensor array 10 and converts the voltage measurements into digital temperature signals. In certain embodiments, gain amplifier 402 and temperature amplifier 404 are wirelessly connected to the input/output interface 406. In certain embodiments, input/output interface 406 is wirelessly-enabled and wirelessly connected to a cloud-based server or mobile device 70. In one or more embodiments, input/output interface 406 and central processing unit 408 may be in a single-board computer. Memory 412 is coupled to the central processing unit 408. Memory 412 stores an operating system for central processing unit 408. In certain embodiments, memory 412 includes memory card, USB-based memory drive, or any digital storage device that may be coupled to central processing unit 408. In certain embodiments, memory 412 stores operational data. The input/output interface 406 may be coupled to HVAC control relay 410. In certain embodiments, HVAC control relay 410 may be Wi-Fi or Bluetooth enabled. In certain embodiments, HVAC control relay 410 is connected directly to the HVAC system and may turn HVAC system 100 on and off. In certain embodiments, HVAC control relay 410 may increase or decrease HVAC system 100 load. In certain embodiments, input/output interface 406 is connected thermostat 28 to turn HVAC system 100 on and off. In certain embodiments, input/output interface 406 is wirelessly connected to user display 414. In certain embodiments, input/output interface 406 is wirelessly connected to cloud server 416. In certain embodiments, cloud server 416 includes database server 418. Database server 418 may store thermostat 28 signal information, thermostat 28 temperature settings, data gathered from sensors in sensor array 10, system and component information for HVAC system, component and parts information for inventory and inventory management on systems having predictive HVAC equipment monitoring system 1, and performance metrics for HVAC systems having predictive HVAC equipment monitoring system 1 with similar capacities and efficiencies. In certain embodiments, cloud server 416 includes an application server 420. Application server 420 hosts operating system for predictive HVAC controlling unit 38.

In certain embodiments, predictive HVAC controlling unit 38 is configured to receive gain-based digital values and digital temperature signals from gain amplifier 402 and temperature amplifier 404, respectively. In certain embodiments, predictive HVAC controlling unit 38 is further configured to process gain-based digital values and digital temperature signals to determine optimal efficiency refrigerant parameters, analyze HVAC system 100 efficiency, predict system failure, output HVAC system 100 efficiency, and output control signals to HVAC control relay 410. In certain embodiments, HVAC control relay 410 inputs control signals and switches for high and low voltage devices and turns the system off and on based on the analysis of gain-based digital values and digital temperature signals and determination of optimal efficiency refrigerant parameters. In certain embodiments, HVAC control relay 410 varies HVAC system 100 speed, increasing or decreasing system load, based on modulating refrigerant parameters to stay within optimal efficiency parameters. In certain embodiments, gain amplifier 402, temperature amplifier 404, input/output interface 406, central processing unit 408, HVAC control relay 410, memory 412 and other required components may be combined into one board and serve as predictive HVAC controlling unit 38.

Predictive HVAC controlling unit 38 is configured to receive refrigerant, air, and system characteristics data from sensor array 10, convert analog signals of the refrigerant and air characteristics data to digital signals, amplify the digital signals, calibrate data, process the digital signals by calculating key system parameters, determine whether a potential failure modality exists or is eminent, take control of the HVAC system 100 to prevent system failure or shift the refrigerant parameters towards optimal efficiency. In some embodiments, refrigerant and air characteristics data includes temperature, pressure, relative humidity, and static pressure measurements from sensors in sensor array 10. In some embodiments, system characteristics data includes data from water leak sensor 72, float switch 76, or sail switch 78. In certain embodiments, predictive HVAC controlling unit 38 is configured to receive thermostat 28 signal information and thermostat 28 temperature settings. Thermostat 28 signal information may include cooling, heating, air conditioning on, fan on, or off conditions. In some embodiments, predictive HVAC controlling unit 38 is configured to receive refrigerant and air characteristics data from the sensor array 10, convert analog signals of the refrigerant and air characteristics data to digital signals, and send digital signals to cloud server 416. In some embodiments, cloud server 416 may receive digital signals, calibrate data, process the digital signals by calculating real-time system parameters, determine whether a potential failure modality exists or is eminent, and send signals to predictive HVAC controlling unit 38 or directly to HVAC system 100 to control HVAC system 100. In some embodiments, digital signals and data are stored in cloud server 416 and may be used for future calculations. In some embodiments, predictive HVAC controlling unit 38 is configured to communicate with predictive HVAC controlling units installed on nearby HVAC systems.

In some embodiments, predictive HVAC controlling unit 38 may take control of the HVAC system 100 by turning the system on or off. In certain embodiments, predictive HVAC controlling unit 38 increases or decreases load on the HVAC system to shift the refrigerant parameters towards optimal efficiency. Predictive HVAC controlling unit 38 is further configured to communicate to an end user, operational parameters of the HVAC system 100 and a determination of a potential eminent failure modality. The end user may be anyone who has responsibility for the maintenance of the building or is tasked with monitoring or maintaining the functionality of the building's HVAC system including but not limited to a building manager, building owner, leasor, leasee, or a monitoring service. In certain embodiments, the end user may be a HVAC system manufacturer or OEM parts distributor. In certain embodiments, predictive HVAC controlling unit 38 is further configured to compare performance of HVAC system 100 with other HVAC systems having of predictive HVAC equipment monitoring system 1 installed on them to compare load and efficiency of performance.

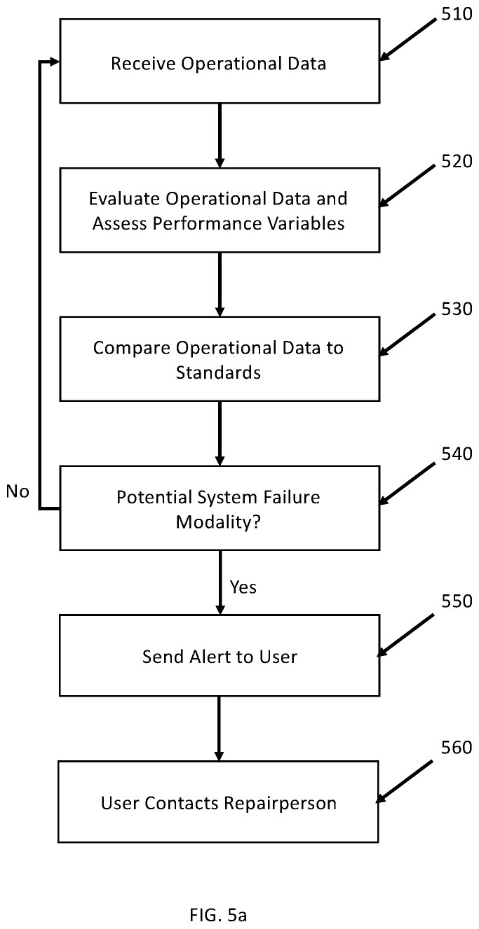

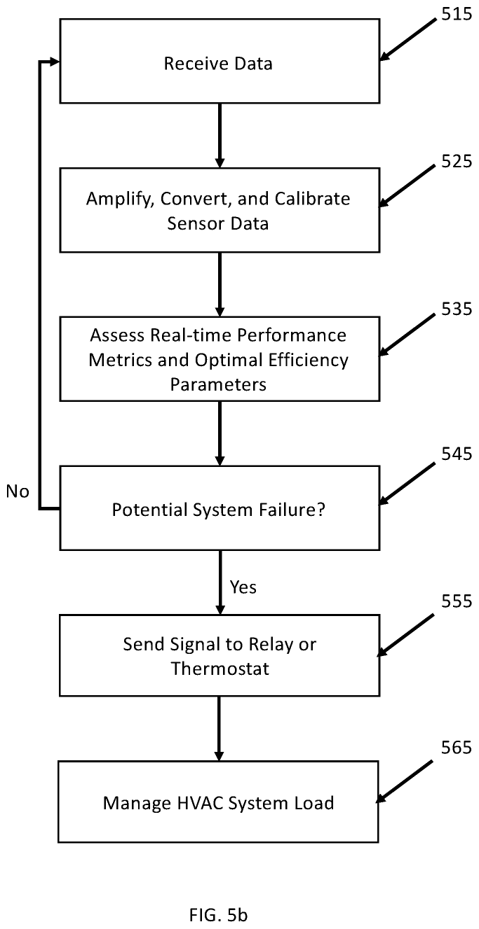

FIG. 5a shows a flowchart in accordance with one or more embodiments of the present invention. Specifically, FIG. 5a shows a flowchart of a method for predicting an operating problem with an HVAC system and alerting the building manager, building owner, leasor, leasee, homeowner, a monitoring service, manufacturer, or OEM parts distributor regarding the problem in accordance with one or more embodiments of the invention. In one or more embodiments of the invention, one or more of the steps described with respect to FIG. 5a may not be performed, may be performed in a different order, and/or may be repeated. Accordingly, the specific arrangement of steps shown in FIG. 5a should not be construed as limiting the scope of the invention in any way.

In one or more embodiments of the invention, at 510, predictive HVAC controlling unit 38 receives refrigerant and air characteristics data from a plurality of sensors in sensor array 10. Specifically, the plurality of sensors in sensor array 10 are disposed at key points in predictive HVAC equipment monitoring system 1 allowing for temperature, pressure, relative humidity, and static pressure measurements of refrigerant or air circulating in the system, water leak detection, and stoppage of air flow. Different types of sensors are discussed above with respect to FIGS. 1, 3, and 4. The plurality of sensors may include sensors 30, 32, 34, 36, 44, 48, 52, 54,56, 60, 66, 68, 80, 82, 84, and 86. In certain embodiments, at 510, predictive HVAC controlling unit 38 receives system characteristics data from sensors 72, 76, and 78, thermostat 28 signal information, and thermostat 28 temperature settings. Refrigerant and air characteristics data, system characteristics data, thermostat signal information, and thermostat temperature settings may be collectively known as operational data. The plurality of sensors in sensor array 10 further sends the refrigerant and air characteristics data and other operational data to the predictive HVAC controlling unit 38.

Based on the received operational data, at 520, predictive HVAC controlling unit 38 evaluates the refrigerant and air characteristics data. In certain embodiments, predictive HVAC controlling unit 38 further evaluates system characteristics data, thermostat signal information, and thermostat temperature settings, assessing performance variables. In certain embodiments, at 530, predictive HVAC controlling unit 38 compares the performance variables to standard ranges for efficient performance of HVAC system 100. In certain embodiments, the standard ranges are manufacturer-set standards. In an alternative embodiment, at 530, predictive HVAC controlling unit 38 compares the performance variables to past operational data. In certain embodiments, at 530, predictive HVAC controlling unit 38 compares the performance variables to manually inputted operational standards. In a further embodiment of the invention, at 530, predictive HVAC controlling unit 38 applies the performance variables to a performance algorithm. In an alternative embodiment, at 530, predictive HVAC controlling unit 38 compares operational data of HVAC system 100 to other HVAC systems having predictive HVAC equipment monitoring systems installed on the other HVAC systems. In certain embodiments, at 530, predictive HVAC controlling unit 38 utilizes a combination of the above-mentioned methods to analyze the performance variables.

At 540, the predictive operations unit determines potential failure modalities based on the analysis made at 530. In an alternate embodiment of the invention, the predictive operations unit evaluates and prioritizes potential failure modalities. If no potential failure modalities are determined at 540, the predictive operations unit returns to 510 to receive further operational data. If at least one potential failure modality is determined at 540, the predictive operations unit, at 550, sends an alert message to an end user informing the end user of the at least one determined potential failure modalities from 540. In an embodiment of the invention, predictive operations unit sends an alert message for each potential failure modality determined. In a further embodiment of the invention, the alert message is specifically tailored to the determined potential failure modality. In an embodiment of the invention, the alert message includes an advisory message based on the potential failure modality. At 560, the end user contacts a repairperson to inspect the HVAC system and rectify any issues found.

In an alternate embodiment of the invention, at 550, the alerts are sent to a monitoring service. In an embodiment of the invention the monitoring service informs the owner of the building of an eminent system issue. The building owner contacts a repairperson to inspect the HVAC system and rectify any issues that may be apparent. In a further alternate embodiment of the invention the monitoring service directly contacts a repairperson to inspect the HVAC system and rectify any issues that may be apparent. In a yet further alternate embodiment of the invention predictive HVAC controlling unit 38 directly contacts a preferred repairperson to inspect the HVAC system and rectify any issues that may be apparent. In a yet further alternate embodiment of the invention, predictive HVAC controlling unit 38 sends a notification to HVAC system 100 manufacturer or an OEM parts distributor.

FIG. 5b shows a flowchart in accordance with one or more embodiments of the present invention. Specifically, FIG. 5b shows a flowchart of a method for predicting an operational problem with an HVAC system, alerting a responsible party regarding the problem, and taking control of the HVAC system to prevent an HVAC system failure. In certain embodiments, one or more of the steps described with respect to FIG. 5b may not be performed, may be performed in a different order, and/or may be repeated. Accordingly, the specific arrangement of steps shown in FIG. 5b should not be construed as limiting the scope of the invention in any way.

At 515, predictive HVAC controlling unit 38 receives sensor data from sensor array 10. Sensors 30, 32, 34, 36, 44, 48, 52, 54,56, 60, 66, 68, 80, 82, 84, and 86 in sensor array 10 are disposed at key points in HVAC system 100 allowing for temperature, pressure, relative humidity, and static pressure measurements of refrigerant or air circulating in HVAC system 100, also known as refrigerant and air characteristics data. In certain embodiments, at 515, predictive HVAC controlling unit 38 further receives system characteristics data from sensors 72, 76, and 78, thermostat signal information, and thermostat temperature settings. Refrigerant and air characteristics data, system characteristics data, thermostat 28 signal information, and thermostat 28 temperature settings may be collectively known as operational data. Different types of sensors are discussed above with respect to FIGS. 1, 2, and 3.

Sensor data is received in analog with a measurement range of 0 to 100 millivolts. At 525, predictive HVAC controlling unit 38 converts, amplifies, and calibrates an analog measurement to digital signal. In certain embodiments, sensor data includes a plurality of analog signals that are amplified and converted to digital signals. In certain embodiments, temperature amplifier 404 amplifies temperature measurements in analog and converts temperature measurements in analog to digital temperature signals. In certain embodiments, gain amplifier 402 amplifies pressure measurements in analog and converts pressure measurements in analog to digital pressure signals. By way of example, in certain embodiments, sensor data includes two analog pressure measurements from a differential pressure transducer and each analog pressure measurement is converted at 525 to a digital signal. In such an embodiment, at 525, one digital signal may be subtracted from the other to determine a differential digital pressure signal. At 535, predictive HVAC controlling unit 38 assesses real-time performance metrics using the converted sensor data, or temperature and pressure digital signals by calculating real-time performance metrics and ascertaining optimal efficiency parameters. In certain embodiments, at 535, predictive HVAC controlling unit 38 further assesses real-time performance metrics using system characteristics data from sensors 72, 76, and 78, thermostat signal information, and thermostat temperature settings. In certain embodiments, temperature amplifier 404 sends temperature digital signals to input/output interface 406, gain amplifier 402 sends pressure digital signals to input/output interface 406, and input/output interface 406 sends temperature and pressure digital signals to central processing unit 408. In certain embodiments, central processing unit 408 of predictive HVAC controlling unit 38 calculates and evaluates real-time performance metrics using the converted sensor data or temperature and pressure digital signals.

In certain embodiments, at 545, predictive HVAC controlling unit 38 compares real-time performance metrics to optimal efficiency parameters to determine a potential HVAC system 100 failure. In certain embodiments, application server 420 hosting operating system of predictive HVAC controlling unit 38 compares real-time performance metrics to optimal efficiency parameters to determine a potential HVAC system 100 failure. In certain embodiments, central processing unit 408 of predictive HVAC controlling unit 38 compares real-time performance metrics to optimal efficiency parameters to determine a potential HVAC system 100 failure. In certain embodiments, the optimal efficiency parameter may be represented by one or more ranges of data, which when compared to the real-time performance metrics, indicate whether the HVAC system 100 is operating in a functional, dangerous, or critical manner. In certain embodiments, the optimal efficiency parameter may be represented by user preferences. In certain embodiments, the optimal efficiency parameter may be a manufacturer standard. In certain embodiments, the optimal efficiency parameter may be a manually inputted operational standard. In certain embodiments, the optimal efficiency parameter may be based on historical operational data. In certain embodiments, the optimal efficiency parameter may be based on operational data from other HVAC systems having predictive HVAC equipment monitoring systems installed on the other HVAC systems. In certain embodiments, predictive HVAC controlling unit 38 is configured to receive present and future local weather data from cloud server 416, store present and future weather data in memory 412, and optimal efficiency parameter may be based on future weather. In certain embodiments, the optimal efficiency parameter may be based on a combination of the above-mentioned methods to analyze the real-time performance metrics.

In certain embodiments, real-time performance metrics are reported to an end user with indications of whether the real-time performance metrics are within functional, dangerous, or critical ranges. In certain embodiments, real-time performance metrics may be stored in and exported from memory 412 for analysis by end user. In certain embodiments, predictive HVAC controlling unit 38 compares real-time performance metrics to optimal efficiency parameters to determine how HVAC system 100 can run more efficiently. If no potential failure is determined at 545, predictive HVAC controlling unit 38 receives further sensor data or operational data 515. If at least one potential system failure is determined at 545, input/output interface 406 sends a signal to HVAC control relay 410 or thermostat 28, at 555, to manage HVAC system 100 load by shutting down, ramping up or down, or turning on HVAC system 100, at 565. In certain embodiments, predictive HVAC controlling unit 38 sends a signal to speed up or down HVAC system 100 so that HVAC system 100 runs more efficiently. In certain embodiments, predictive HVAC controlling unit 38 sends an alert message to end user informing end user of the at least one determined potential system failure from 545. In certain embodiments, the alert is sent to a monitoring service. The monitoring service may directly contact a repairperson to inspect the HVAC system and rectify any issues that may be apparent. In other embodiments, predictive HVAC controlling unit 38 directly contacts a repairperson to inspect the HVAC system and rectify any issues that may be apparent. In a yet further alternate embodiment of the invention, predictive HVAC controlling unit 38 sends a notification to HVAC system 100 manufacturer or an OEM parts distributor.

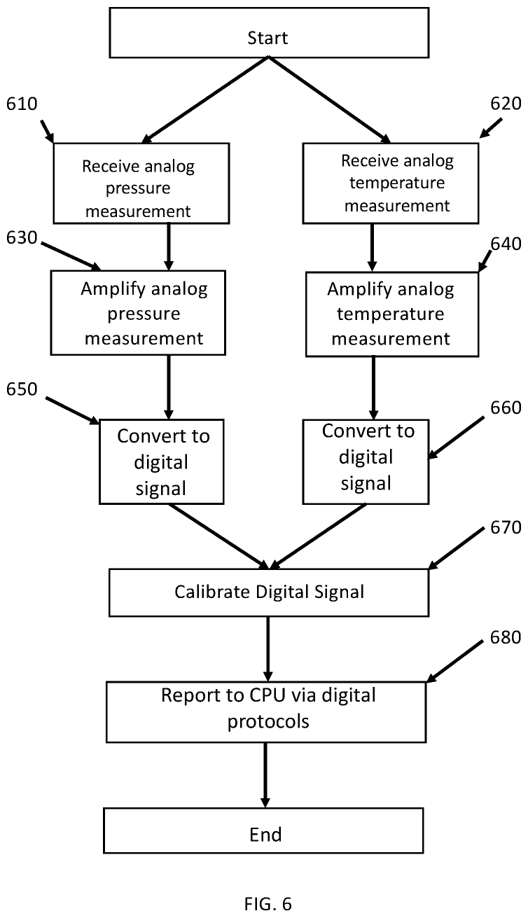

FIG. 6 shows a detailed flowchart of the steps as described in 525 of the present application in accordance with one or more embodiments of the present invention. By way of example, in certain embodiments at 610, sensor data including an analog pressure measurement of liquid vapor is received by gain amplifier 402 from a pressure sensor in sensor array 10. At 620, sensor data further includes an analog temperature measurement of liquid vapor received by temperature amplifier 404 from a temperature sensor in sensor array 10. Gain amplifier 402 amplifies analog pressure measurement at 630. Temperature amplifier 404 amplifies analog temperature measurement at 640. In certain embodiments, sensor data is amplified from millivolts to volts. In certain embodiments, sensor data is amplified to volts depending on a measurement range of the sensor data. At 650, amplified analog pressure measurement is converted from an analog measurement to a digital pressure signal having digital values by the gain amplifier 402. At 660, amplified analog temperature measurement is converted from an analog measurement to a digital temperature signal having digital values by the temperature amplifier 404. In certain embodiments, analog sensor data is converted to digital signals using a 16-bit amplifier. The type and level of amplification may be configured based on type of sensor data or application of sensor data. In certain embodiments, the amplified analog temperature measurement is mapped to a range of digital values that represents the digital temperature signal. At 670, digital pressure signal and digital temperature signal are calibrated. In certain embodiments, a pre-determined calibration ratio is used to calibrate the digital temperature signal. In certain embodiments, the pre-determined calibration ratio may be a ratio of a calibration reference temperature over a calibration digital temperature signal. The pre-determined calibration ratio may be configured prior to use of the predictive HVAC controlling unit 38. The digital pressure signal may be calibrated in a similar way using a calibration reference pressure. At 680, calibrated digital temperature signal and calibrated digital pressure signal are sent to central processing unit 408 using digital protocols through the input/output interface 406. Any commercially available wired and wireless digital protocols may be used.

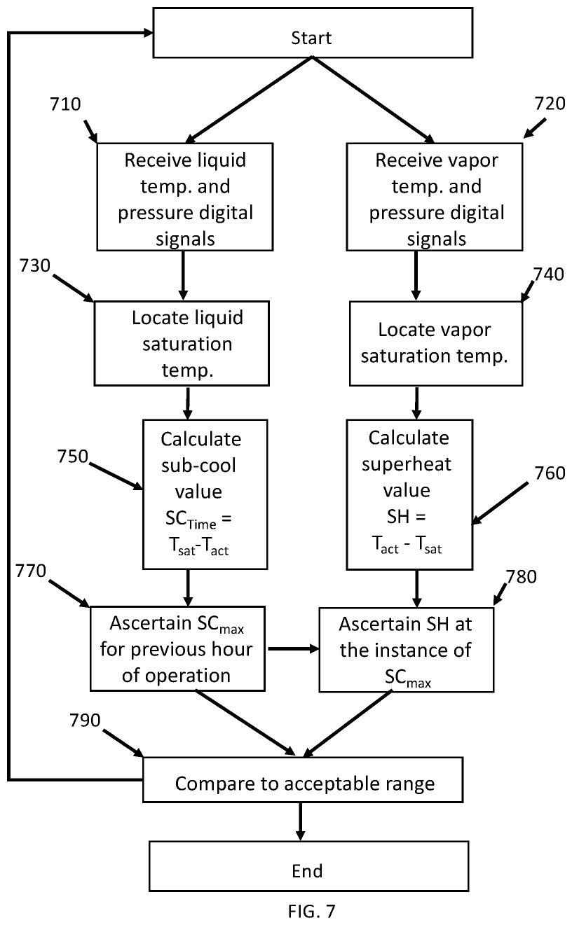

FIG. 7 shows a detailed flowchart of the steps as described in 535 of the present application in accordance with one or more embodiments of the present invention. In certain embodiments, real-time performance metrics and optimal efficiency parameters include capacity, communications and controls, charge level, electrical current, flow volume, mass flow rate, power, pressure, relative humidity, rotational speed, subcooling, superheat, temperature, water leakage, air flow, dry bulb temperature, static pressure, thermostat 28 signal information, flow velocity, and voltage. By way of example, FIG. 7 shows the assessment of subcooling and superheat real-time performance metrics by the predictive HVAC controlling unit 38. At 710, liquid temperature and pressure digital signals are received by central processing unit 408. At 720, central processing unit 408 receives vapor temperature and pressure digital signals. At 730, a liquid saturation temperature is located and ascertained. At 740, a vapor saturation temperature is located and ascertained. At 750, central processing unit 408 calculates subcooling for HVAC system 100 at a specific time as the difference of the liquid saturation temperature and the actual temperature derived from the liquid temperature digital signal. At 760, central processing unit 408 calculates superheat for HVAC system 100 at a specific time as difference of the actual temperature from the vapor temperature digital signal and the vapor saturation temperature. In certain embodiments, central processing unit 408 sends subcooling values for a specific time to memory 412 to store for future use. At 770, central processing unit 408 ascertains a maximum subcooling value at a specific time from a prior hour of operation. At 780, central processing unit 408 ascertains a superheat value at the specific time of the maximum subcooling value. In certain embodiments, at 790 a temperature and pressure digital signals are reviewed to ensure that they are in acceptable ranges. In certain embodiments, the acceptable range may be above zero.

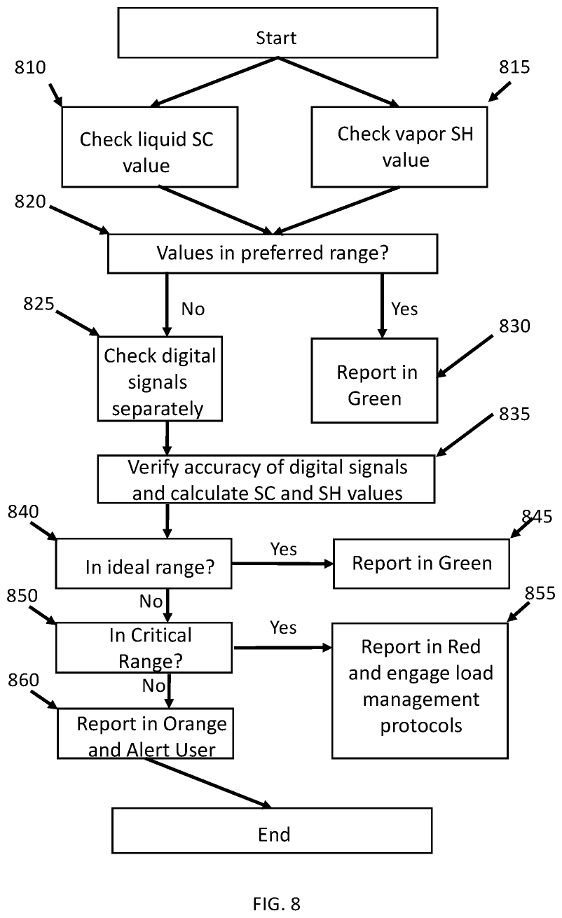

FIG. 8 shows a detailed flowchart of the steps as described in 545 of the present application in accordance with one or more embodiments of the present invention. By way of example, FIG. 7 shows the determination of whether a potential system is eminent based on liquid subcooling and vapor superheat values as determined in FIG. 7. At 810 the central processing unit 408 checks the liquid subcooling value. At 815, the central processing unit 408 checks the vapor superheat value. At 820, the central processing unit 408 determines whether the liquid subcooling or vapor superheat values are within a functioning or preferred range. If so, at 830, the liquid subcooling or vapor superheat values are reported to an end user. If the liquid subcooling or vapor superheat values are not in a functioning or preferred range, at 825, the central processing unit 408 checks the temperature and pressure digital signals separately and independently. At 835 the central processing unit 408 verifies the accuracy of the temperature and pressure digital signals and calculates the subcooling and superheat values based on the verified temperature and pressure digital signals. At 840, the central processing unit 408 determines whether the subcooling and superheat values are within an ideal or functioning range and if so at 845, the subcooling and superheat values are reported to an end user with an indication that subcooling and superheat values are in the ideal or functioning range. In certain embodiments, the indication of the values being in the ideal or functioning range is that the reported values are highlighted in green. If the subcooling and superheat values are not within an ideal or functioning range, the central processing unit 408 at 850 determines whether the subcooling and superheat values are within a critical range. If the subcooling and superheat values are within the critical range then an imminent HVAC system 100 failure or an indication of a failure modality has been determined and at 855, the subcooling and superheat values are reported to an end user with an indication that subcooling and superheat values are in the critical range and the central processing unit 408 sends an instruction to the input/output interface 406 to send a signal to relay 410 based on load management protocols engaging load management protocols. In certain embodiments, the critical range represents a range of values that may indicate a system failure of the HVAC system 100. In certain embodiments, the indication of the values being in the critical range is that the reported values are highlighted in red. If the subcooling and superheat values are not within the critical range, at 860, the subcooling and superheat values are reported to an end user with an indication that subcooling and superheat values are in a dangerous range. In certain embodiments, the indication of the values being in the dangerous range is that the reported values are highlighted in orange. In certain embodiments, when a real-time performance metric is in the dangerous range, load management protocols may be engaged. In certain embodiments, the functioning, dangerous, and critical ranges are user-defined. In certain embodiments, the alerts and reporting mechanisms to the end user are user-defined. In certain embodiments, the HVAC system 100 load management protocols are user-defined.

While the principles of the invention have been described herein, it is to be understood by those skilled in the art that this description is made only by way of example and not as a limitation as to the scope of the invention. Further embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A predictive HVAC monitoring system comprising:
an HVAC system;
a first sensor of a sensor array disposed a vapor refrigerant line exiting from an evaporating unit of the HVAC system, the first sensor being adapted to gather pressure data;
a second sensor of the sensor array disposed on a vapor refrigerant line entering a compressor of the HVAC system, the second sensor adapted to gather temperature data; and
a predictive HVAC controlling unit, the predictive HVAC controlling unit adapted to receive and evaluate the temperature data and the pressure data to determine whether a potential failure modality exists or is eminent, the first sensor further adapted to communicate with the predictive HVAC controlling unit, and the second sensor further adapted to communicate with the predictive HVAC controlling unit.

2. The predictive HVAC monitoring system of claim 1 wherein the sensor array includes a pressure sensor disposed on a liquid refrigerant line entering into the evaporating unit of the HVAC system.

3. The predictive HVAC monitoring system of claim 1 wherein the sensor array includes a temperature sensor disposed on a liquid refrigerant line exiting from the condensing unit of the HVAC system.

4. The predictive HVAC monitoring system of claim 1 wherein the predictive HVAC controlling unit is further adapted to alert an end user if a potential failure modality has been determined.

5. The predictive HVAC monitoring system of claim 1 wherein the sensor array includes an air inlet temperature sensor disposed on an external surface of an outdoor HVAC unit of the HVAC system, proximate to a condensing unit of the HVAC system, and adjacent to an inlet vent of the HVAC system.

6. The predictive HVAC monitoring system of claim 1 wherein the sensor array includes an air outlet temperature sensor disposed on an external surface of an outdoor HVAC unit of the HVAC system, above a condensing unit of the HVAC system, and adjacent to an outlet fan of the HVAC system.

7. The predictive HVAC monitoring system of claim 1 wherein the sensor array includes an air inlet static pressure sensor disposed on an external surface of an outdoor HVAC unit of the HVAC system lateral to a condensing unit of the HVAC system and adjacent to an inlet vent of the HVAC system.

8. The predictive HVAC monitoring system of claim 1 wherein the sensor array includes an air outlet static pressure sensor disposed on an external surface of an outdoor HVAC unit of the HVAC system above a condensing unit of the HVAC system and adjacent to an outlet fan of the HVAC system.

9. The predictive HVAC monitoring system of claim 1 wherein the sensor array includes a return air temperature sensor disposed on an interior surface of a return air duct of the HVAC system, the return air temperature sensor configured to determine a dry bulb temperature within the return air duct.

10. The predictive HVAC monitoring system of claim 1 wherein the sensor array includes a supply air temperature sensor disposed on an interior surface of a supply air duct of the HVAC system, the supply air temperature sensor configured to measure dry bulb temperature within the supply air duct.

11. A predictive HVAC system controlling apparatus comprising:
an input/output interface connected to a gain amplifier and a temperature amplifier, the gain amplifier connected to a first sensor disposed on an HVAC system, the HVAC system having HVAC system controls, and the temperature amplifier connected to a second sensor disposed on an HVAC system;
a central processing unit connected to the input/output interface; and
an HVAC control relay connected to the input/output interface and HVAC system controls.

12. The predictive HVAC system controlling apparatus of claim 11 wherein the input/output interface is wirelessly connected to a cloud server, said cloud server comprising a database server.

13. The predictive HVAC system controlling apparatus of claim 11 wherein the input/output interface is wirelessly connected to a cloud server, said cloud server comprising an application server.

14. A method for predictively controlling an HVAC system to prevent system malfunction comprising:
sending sensor data from an array of sensors disposed on the HVAC system;
receiving said sensor data by at least one amplifier;
amplifying said sensor data;
converting said sensor data to a digital signal;
calibrating said digital signal;
calculating a real-time performance metric based on said digital signal;
assessing the real-time performance metric based on an optimal efficiency parameter; and
determining whether a potential system failure is imminent, wherein said real-time performance metric comprises at least one of capacity, communications and controls, charge level, electrical current, flow volume, mass flow rate, power, pressure, relative humidity, rotational speed, subcooling, superheat, temperature, water leakage, air flow, dry bulb temperature, static pressure, thermostat signal information, flow velocity, and voltage.

15. The method for predictively controlling an HVAC system to prevent system malfunction of claim 14 further comprising sending a signal to a relay to manage HVAC system load.

16. The method for predictively controlling an HVAC system to prevent system malfunction of claim 14 further comprising reporting to an end user said real-time performance metric.

17. The method for predictively controlling an HVAC system to prevent system malfunction of claim 14 further comprising reporting to an end user an indication of whether said real-time performance metric is within a functional, dangerous, or critical range.

18. The method for predictively controlling an HVAC system to prevent system malfunction of claim 14 wherein said step of determining whether a potential system failure is imminent comprises comparing said real-time performance metric to said optimal efficiency parameter.

19. The method for predictively controlling an HVAC system to prevent system malfunction of claim 18 wherein said optimal efficiency parameter comprises a range of data indicating whether said HVAC system is operating in a functional, dangerous, or critical manner.

20. The method for predictively controlling an HVAC system to prevent system malfunction of claim 18 wherein said step of determining whether a potential system failure is imminent comprises comparing said real-time performance metric to said optimal efficiency parameter to determine how said HVAC system can run more efficiently.
